(19) United States
(12) Patent Application Publication
(10) Pub. No.: US 2008/0140455 A1
(43) Pub. Date: Jun. 12, 2008

(54) Filing of health and health-care data

(76) Inventor: Anuthep Benja-Athon, New York, NY (US)

Correspondence Address: Anuthep Benja-Athon, 210 E. 36th St., New York, NY, 10016, US

(21) Appl. No.: 12/069,409

(22) Filed: Feb. 11, 2008

Related U.S. Application Data
(63) Continuation-in-part of application No. 11/986,657, filed on Nov. 26, 2007.
Application No. 11/986,657 is a continuation-in-part of application No. 11/803,621, filed on May 16, 2007.
Application No. 11/803,621 is a continuation-in-part of application No. 11/114,763, filed on Apr. 27, 2005.
Application No. 11/114,763 is a continuation-in-part of application No. 11/973,823, filed on Oct. 10, 2007.
Application No. 11/973,823 is a continuation-in-part of application No. 11/973,866, filed on Oct. 11, 2007.
Application No. 11/973,866 is a continuation-in-part of application No. 11/543,895, filed on Oct. 6, 2006.
Application No. 11/543,895 is a continuation-in-part of application No. 11/510,820, filed on Aug. 28, 2006.
Application No. 11/510,820 is a continuation-in-part of application No. 11/477,121, filed on Jun. 29, 2006.
Application No. 11/477,121 is a continuation-in-part of application No. 11/477,121, filed on Jun. 29, 2006.
Application No. 11/477,121 is a continuation-in-part of application No. 11/431,046, filed on May 10, 2006.
Application No. 11/431,046 is a continuation-in-part of application No. 11/022,410, filed on Dec. 27, 2004, now abandoned.
Application No. 11/022,410 is a continuation-in-part of application No. 11/074,236, filed on Mar. 7, 2005.

(51) Int. Cl. G06Q 50/00; G06F 17/30

(52) U.S. Cl. 705/3; 707/104.1; 707/E17.044

(57) ABSTRACT

A system of using, assigning, identifying, searching and locating words and terms in health and health-care data and information in the text files for effecting the organization of the data and information on patients generated by physicians, the displays, manipulations and editions of the data and information, the incorporations, associations and expansions of the data and information by physicians and patients the placements and storage of the data and information in electronic database or databases.

This application is a continuation-in-part of Ser. No. 11/986,657 entitled A hierarchy of medical word headers filed Nov. 26, 2007, a continuation-in-part of Ser. No. 11/803,621 entitled Patients' and physicians' data management filed May 16, 2007, a continuation-in-part of Ser. No. 11/114,763 entitled A system of influencing health-care utilizations filed Apr. 27, 2005, a continuation-in-part of Ser. No. 11/196,823 entitled Routing of health information files filed Aug. 4, 2005, a continuation-in-part of Ser. No. 11/973,866 entitled An intelligent system of speech recognizing physicians' data, a continuation-in-part of Ser. No. 11/543,895 entitled Vital elements of speech recognition filed Oct. 6, 2006, a continuation-in-part of Ser. No. 11/510,820 entitled Words for managing health and health-care information filed Aug. 28, 2006, a continuation-in-part of Ser. No. 11/477,121 entitled the Medical Vocabulary Templates in Speech Recognition filed Jun. 29, 2006, a continuation-in-part of Fidelity of physicians' thoughts to digital data conversions filed Jan. 9, 2006, a continuation-in-part of Ser. No. 11/431,046 entitled A system of health-care information management filed Nov. 2, 2006, and a continuation-in-part of Ser. No. 11/022,410 entitled Physicians' way of information productions filed Dec. 27, 2004, a continuation-in-part of Ser. No. 11/074,236 entitled A system of management of health-care resources filed Mar. 7, 2005 which are pending.

### FIELD OF INVENTION

A method of using words and terms for filing of health and health-care data and information.

### BACKGROUND OF THE INVENTION

The concepts of and means for generating health and health-care data and information on patients by physicians and the incorporations into and relations of said data and information to the larger health and health-care data and information generated by patients and physicians are taught in said pending patent applications.

However, the system and method of using the means for filing health and health-care data and information and for effecting the associations, incorporations and relations of said data and information were heretofore either not achieved, described or not detailed. Therefore, the present invention provides a system and a method to achieve the objectives and goals described herein.

The present invention together with said pending patent applications are the only means and solution for solving the current health and health-care woes affecting all Americans and, consequently, they produce the best health-care system the world ever known and have and the benefits for billions of people and humanity are immense.

### SUMMARY OF THE INVENTION

Said pending applications teach the combinations or merging of health and health-care data and information on patients generated by physicians initially as digital voice data and information which are speech recognized into electronic text data and information which are associated, incorporated and related with first health and health-care data and information generated by typing by patients and physicians. However, in said pending patent applications, the system and method leading to supra were not taught.

The present invention provides a system and a method of using, assigning, identifying, searching and locating words and terms in health and health-care data and information in the text files and of using said words and terms in electronic templates for effecting the organization of the data and information on patients generated by physicians, the displays, manipulations and editions of the data and information, the incorporations, associations and expansions of the data and information by physicians and the placements and storage of the data and information in electronic database or databases.

### DESCRIPTION OF THE PREFERRED EMBODIMENTS

Said pending patent applications taught innovations including an innovative system of speech recognition or the conversion of voice data and information on health and health-care data and information on patients generated by physicians into text data and information. Furthermore, said pending patent applications taught a system and a method for assigning and using words, terms and phrases in health and health-care data and information by physicians for the managements of said data and information to achieve the goals and objectives in said pending applications.

Further to supra, the present invention provides a system and a method of empowering the words, terms and phrases to achieve the objectives and goals of said applications and stated herein. Specifically, the present invention provides a system and a method of finding or searching, identifying, using and applying word headers and term headers henceforth known as word and term headers to achieve the objectives and goals of said applications and stated herein.

One of the preferred embodiments of the present invention is the identifying, finding or searching and accounting for the locations and relationships of words, terms and phrases in individual text files for getting and placing said data and information into organized displays of health and health-care data and information on patients for effecting the visual displays and inspections of said data and information on the viewing screens of electronic devices and manipulations including corrections and editions of and additions to said data and information and the submissions of said data and information by said physicians, the placements of said data and information into the electronic database or databases and wherein said words and terms effect the insertions or placements of said data and information henceforth also known as second health and health-care data and information and for effecting the retrievals of health and health-care data and information from the database or databases for incorporations with first health and health-care data and information generated by patients and physicians, for effecting the relations of said data and information in the database or databases, for effecting the displays of said data and information and wherein the resultant products of said processes, integrations, associations and relations of said data and information are retrieved and viewed on the viewing screens, comprehended, manipulated and edited, and more data and information are added to said products by patients and physicians.

First, the present invention provides a method of using word and term headers in the outcomes of speech recognition of health and health-care data and information on patients generated by physicians to give said physicians the views, manipulations and editions of said data and information and the data and information on the monetary values and payments of services rendered by said physicians credited to said physicians' accounts and to effect the placements of said data and information into the electronic databases. This word and term means for placing said data and information in the organized displays of data and information for visual inspections by said physicians, for effecting the visual inspections of said data and information on the viewing screens of electronic devices and manipulations including corrections and editions of and additions to said data and information and the submissions of said data and information by said physicians and the placements of said data and information into the electronic databases are used or implemented by the computer program or programs of the present patent applicant.

As taught by said pending patent applications, one of the preferred embodiments representing the outcomes of speech recognition of health and health-care data and information on patients generated by physicians are individual strings of health and health-care data and information each of which comprises couples, couplets or couplings (henceforth couplings) of word and term headers—bold Arial words and terms infra—and related health and health-care words, terms, phrases and sentences—a plurality of groups of “*” infra. Said one of the preferred embodiments can be represented as follows:

### Evaluation **** Chief Complaint *** Review of Systems ***** Physical Examination ****** Diagnosis ***** Differential Diagnosis ****** Treatment ****** Medication ****** Surgery ***** Recommendation ***** Follow Up ****

wherein said string of words, terms and phrases are paired into couplings of words, terms, phrases and sentences. Said bold Arial word and term headers (see also infra) and the like word and term headers. Each “****” supra following or to the right of each said header representing related words, terms, phrases and/or sentences known as secondary text (see New Time Roman words, terms and phrases infra) relating to said header to the left or preceding said text. Another representation of said string of couplings—of an immense number of strings comprising word and term headers and related words, terms, phrases and sentences—as one of the possible outcome of said speech recognition is as follows:

Evaluation Simple Office Visit Chief Complaint Headache duration 10 days Review of Systems Abdominal pain fever diarrhea Physical Examination malaise hyporeflexia Diagnosis Cluster migraine Differential Diagnosis intestinal viral infection typhoid fever Treatment nasogastric tube insertion feeding intravenous hydration Medication oral ibuprofen 200 milligrams 2 tablets Surgery bursa injection Recommendation Rest Follow Up return to clinic in 2 weeks

The present invention provides a system or method of finding or searching, identifying and using said headers in individual strings of couplings each of which comprises a header and related secondary text. In other words, the present invention provides a computer program or computer programs which process said strings numbering in the thousands to millions each day and, in each said string, by finding or searching and identifying or locating the said headers and therefore, said headers' respective secondary texts. The present invention provides the system and method of determining the identities, locations and presences of said headers, the order of said headers or the disorders of the headers and related secondary texts and repeat also known as doublet or repeats of headers or doublets and related secondary texts or the lack of related secondary text or texts, etc.

Therefore, an ordered string—for which most strings of health and health-care data and information on patients generated by physicians numbering in the thousands to millions each day are and will be as represented by one of the preferred embodiments supra—is processed by the computer program or programs of the present patent applicant. In other word, said order of couplings represents one of the preferred embodiments being a typical and expected order of couplings of words, terms and phrases in a string—as told or instructed to and being obeyed and used by physicians generating the voice data and information on patients' health and health-care information. The present invention provides said program or programs of finding or searching, identifying, locating and accounting for said headers in individual strings of couplings.

For example, as one of the preferred embodiments of the present invention, the following word and term headers and their locations are found and the order of the headers are found and gotten:

### Evaluation **** Chief Complaint *** Review of Systems ***** Physical Examination ****** Diagnosis ***** Differential Diagnosis ****** Treatment ****** Medication ****** Surgery***** Recommendation ***** Follow Up ****

then the related secondary text of each header is found and gotten to the right of its header and preceding the adjacent header. This process is represented in writing as follows:

### Evaluation Office Visit Chief Complaint

### Chief Complaint Headache duration 10 days Review of Systems

### Review of Systems Abdominal pain fever diarrhea Physical Examination

### Physical Examination malaise hyporeflexia Diagnosis

### Diagnosis Cluster migraine Differential Diagnosis

### Differential Diagnosis intestinal viral infection typhoid fever Treatment

### Treatment nasogastric tube insertion feeding intravenous hydration Medication

### Medication oral ibuprofen 200 milligrams 2 tablets Surgery

### Surgery bursa injection Recommendation

### Recommendation Rest Follow Up

### Follow Up return to clinic in 2 weeks

Said brief description approximates the applications of the processing of individual strings of data and information in the conditions stated infra.

One of the preferred embodiments representing the product of one of the processes of the present invention is represented as follows which is viewed, manipulated, edited and used by a physician or physicians before the data and information is submitted by a physician for placement or placements into the computer/server database or databases as further described infra:

### Evaluation Simple Office Visit

### Chief Complaint Headache duration 10 days

### Review of Systems Abdominal pain fever diarrhea

### Physical Examination malaise hyporeflexia

### Diagnosis Cluster migraine

### Differential Diagnosis intestinal viral infection typhoid fever

### Treatment nasogastric tube insertion feeding intravenous hydration

### Medication oral ibuprofen 200 milligrams 2 tablets

### Surgery bursa injection

### Recommendation Rest

### Follow Up return to clinic in 2 weeks

Yet another example of the infinite possibilities of hierarchies of words, terms, phrases and health and health-care data and information is as follows:

Dr. John Dole Patient Jane M. Dole Evaluation Consultation Chief Complaint Fever Malaise Review of Systems Hematuria duration 4 days Nausea vomit 6 days Physical Examination Swollen lymph nodes in the armpits Diagnosis Streptococcal infection Differential Diagnosis Renal failure Glomerulonephritis Laboratory CBC SMA12 Renal CTScan Assessment and Plan Streptococcal Infection Kidney failure Treatment See below Medications Oral prednisone 2 weeks Surgery None Recommendation Reduce protein intake Rest Follow-Up Return in one week

and the result of said process is as follows:

### Dr. John Dole

### Patient Jane M. Dole

### Evaluation Consultation

### Chief Complaint Fever Malaise

### Review of Systems Hematuria duration 4 days Nausea vomit 6 days

### Physical Examination Swollen lymph nodes in the armpits

### Diagnosis Streptococcal infection

### Differential Diagnosis Renal failure Glomerulonephritis

### Laboratory CBC SMA12 Renal CTScan

### Assessment Plan Streptococcal Infection Kidney failure

### Treatment See below

### Medications Oral prednisone 10 days

### Surgery None

### Recommendation Reduce protein intake Rest

### Follow-Up Return in one week

Furthermore, physicians can and do make errors in dictations of health and health-care data and information on patients, these applicants' innovative computer program or programs can detect, correct, present and compensate for the physicians' errors as described infra. In other words, although in the common practice, routinely and orderly, there will be an order—as represent by the first order supra as being a typical and expected order of couplings of words, terms and phrases in a string—as told or instructed to and being obeyed and used by physicians generating the voice data and information on patients' health and health-care information, individual strings of words, terms and phrases such as, but not limited to, the representations herein wherein couplings of words, terms and phrases may or can be omitted or absent, wherein couplings of words and terms may and can be in any orders or arrangements—disorders—in individual strings of words, terms and phrases and wherein repeats of couplings of words and terms may and can be in any orders or arrangements.

For example, second order infra represents a string of disordered couplings of words, terms and phrases further illustrates said ability of said method and process enabled by the present patent applicant's computer program or programs to search and identify the headers of the couplings and to identify and account for the relative positions or locations of the respective related secondary texts to achieve one of the goals and objectives of the present invention.

In the latter three settings of missing couplings, disordered couplings and repeats of couplings—ordered or disordered—and the like, the positions and locations of word and terms headers in individual strings of words, terms and phrases are identified, located, known and accounted by the use of the computer program or programs of the present patent applicant and identifying and accounting for the locations and relationships of related secondary texts based on the processes briefly described supra.

In other words, in any and all strings of couplings of words, terms, phrases and sentences comprising health and health-care data and information, appropriately, on any and all patients generated by physicians as taught by the present applicants' pending patent applications, the identities or searches of the headers are achieved and the relative positions or locations of the respective related secondary texts are identified and accounted for and related by the present applicant's computer program or programs. Said program (or programs) searches and identifies each header follow by identifying related secondary text comprising words, terms, phrases and sentences before and/or after it (referring to said header) and identifying each header with each related secondary text—coupling—to result in the display in the following representation of one of the preferred embodiments of the present invention:

For example, second order infra represents two strings of disordered couplings of words, terms and phrases further illustrates said ability of said method and process enabled by the present patent applicant's computer program or programs to search and identify the headers of the couplings and to identify and account for the relative positions or locations of the respective related secondary texts to achieve one of the goals and objectives of the present invention.

Chief Complaint Headache duration 10 days Review of Systems Abdominal pain fever diarrhea Differential Diagnosis intestinal viral infection typhoid fever Physical Examination malaise hyporeflexia Treatment nasogastric tube insertion feeding intravenous hydration Surgery bursa injection Diagnosis Cluster migraine Evaluation Simple Office Visit Follow Up return to clinic in 2 weeks Recommendation Rest

Chief Complaint Headache duration 10 days Evaluation Simple Office Visit Review of Systems Abdominal pain fever diarrhea Diagnosis Cluster migraine Differential Diagnosis intestinal viral infection typhoid fever Physical Examination malaise hyporeflexia Recommendation Rest Treatment nasogastric tube insertion feeding intravenous hydration Surgery bursa injection Follow Up return to clinic in 2 weeks

and the result representing said two strings after said process is as follows:

### Evaluation Simple Office Visit

### Chief Complaint Headache duration 10 days

### Review of Systems Abdominal pain fever diarrhea

### Physical Examination malaise hyporeflexia

### Diagnosis Cluster migraine

### Differential Diagnosis intestinal viral infection typhoid fever

### Treatment nasogastric tube insertion feeding intravenous hydration

### Surgery bursa injection

### Recommendation Rest

### Follow Up return to clinic in 2 weeks

Yet another example, represents the repeats of headers and their related secondary texts in two string of health and health-care data and information infra further illustrate ability of said method and processes enabled by the applicant's computer program or programs to search and identify the headers of the couplings and to identify and account for the relative positions or locations of the respective related secondary texts to achieve one of the goals and objectives of the present invention.

Chief Complaint Headache duration 10 days Review of Systems Abdominal pain fever diarrhea Differential Diagnosis intestinal viral infection typhoid fever Physical Examination malaise hyporeflexia Treatment nasogastric tube insertion feeding intravenous hydration Surgery bursa injection Diagnosis Cluster migraine Diagnosis Maxillary sinusitis Evaluation Simple Office Visit Recommendation Rest Follow Up return to clinic in 2 weeks

Chief Complaint Headache duration 10 days Review of Systems Abdominal pain fever diarrhea Differential Diagnosis intestinal viral infection typhoid fever Differential Diagnosis amoebic dysentary Physical Examination malaise hyporeflexia Treatment nasogastric tube insertion feeding intravenous hydration Surgery bursa injection Diagnosis Cluster migraine Diagnosis Maxillary sinusitis Evaluation Simple Office Visit Recommendation Rest Follow Up return to clinic in 2 weeks Surgery joint resection

Furthermore, the present invention also address the errors in said data and information wherein a repeat or a plurality of repeats of headers and related secondary texts were generated such as, but not limited to, in these two abbreviated strings of words and terms as a representation:

As stated supra, whatever the orders of couplings are in the data and information, the computer program or programs have been written to take the above and any orders of couplings and achieve an order as represent by one of the preferred embodiments supra. As one of the preferred embodiments, the computer program causes or programs cause the repeats to be shown together as represented infra so that physicians can views, editions, additions, manipulations and then submission to achieve the goals and objectives of the present invention:

### Evaluation Simple Office Visit

### Chief Complaint Headache duration 10 days

### Review of Systems Abdominal pain fever diarrhea

### Physical Examination malaise hyporeflexia

### Diagnosis Cluster migraine

### Diagnosis Maxillary sinusitis

### Differential Diagnosis intestinal viral infection typhoid fever

### Treatment nasogastric tube insertion feeding intravenous hydration

### Surgery bursa injection

### Recommendation Rest

### Follow Up return to clinic in 2 weeks

### Evaluation Simple Office Visit

### Chief Complaint Headache duration 10 days

### Review of Systems Abdominal pain fever diarrhea

### Physical Examination malaise hyporeflexia

### Diagnosis Cluster migraine

### Diagnosis Maxillary sinusitis

### Differential Diagnosis intestinal viral infection typhoid fever

### Differential Diagnosis amoebic dysentary

### Treatment nasogastric tube insertion feeding intravenous hydration

### Surgery bursa injection

### Surgery joint resection

### Recommendation Rest

### Follow Up return to clinic in 2 weeks

By viewing the above on the viewing screens of electronic devices, for example, a physician can manipulate, correct, edit and/or add to achieve infra before submitting the outcome infra into the electronic databases wherein data and information are placed and stored.

### Evaluation Simple Office Visit

### Chief Complaint Headache duration 14 days

### Review of Systems Abdominal pain fever diarrhea

### Physical Examination malaise hyporeflexia

### Diagnosis Maxillary and frontal sinusitis

### Differential Diagnosis intestinal viral infection typhoid fever

### Treatment intravenous hydration

### Surgery bursa injection

### Recommendation Rest

### Follow Up return to clinic in 1 week

### Evaluation Simple Office Visit

### Chief Complaint Headache duration 10 days

### Review of Systems Abdominal pain fever diarrhea

### Physical Examination malaise hyporeflexia

### Diagnosis Maxillary sinusitis

### Differential Diagnosis intestinal viral infection typhoid fever

### Treatment nasogastric tube insertion feeding intravenous hydration

### Surgery joint resection

### Recommendation Rest

### Follow Up return to clinic in 2 weeks

Consequently, regardless the conditions of the strings—missing couplings, disorders and numbers of repeated couplings—physicians' errors—comprising health and health-care data and information on a patient generated by a physician, said computer program or programs is or are able to process every string to achieve one of the preferred embodiments represented supra. In other words, whatever the orders or disorders of couplings and the number of repeats of same or different couplings present in said data and information, said computer program or programs take the above and achieve an order as represent by one of the preferred embodiments infra which is viewed by physicians for editions, additions and manipulations and then submission to achieve the goals and objectives of the present invention:

### Evaluation Simple Office Visit

### Chief Complaint Headache duration 10 days

### Review of Systems Abdominal pain fever diarrhea

### Physical Examination malaise hyporeflexia

### Diagnosis Cluster migraine

### Differential Diagnosis intestinal viral infection typhoid fever

### Treatment nasogastric tube insertion feeding intravenous hydration

### Surgery bursa injection

### Recommendation Rest

### Follow Up return to clinic in 2 weeks

After said manipulations, editions, corrections and additions said data and information supra representing one of the preferred embodiments of the present invention, then the data and information are submitted by said physician clicking “Submit” or the like function and said data and information are placed and stored—based on said headers and the like—by computer programs into the electronic databases.

Second and further to supra, similarly, the present invention provides the uses of said word and term headers based on said preferred embodiments and the like in a template means for accepting health and health-care data and information on patients generated by typing using electronic keyboards by physicians. One of the preferred embodiments of the present invention is represented infra wherein word and term headers are present in individual templates wherein, alternative to the precesses of generation and the conversions of speech-to-text of the voice health and health-care data and information on patients by physicians and said processes, a physicians can use multiple templates to type or enter health and health-care data and information on individual patients to the right of the word and term headers represent infra—one template—by a plurality of “______” represent blank spaces into which physicians can type or enter related secondary texts to produce corresponding one completed template infra:

### Tag Means

### Evaluation ______

### Chief Complaint ______

### Review of Systems ______

### Physical Examination ______

### Diagnosis ______

### Differential Diagnosis ______

### Laboratory ______

### Assessment and Plan ______

### Medications ______

### Treatment ______

### Surgery ______

### Recommendation ______

### Follow-Up ______

The result of said entry of data and information is as follows:

### Tag Means

### Evaluation Consultation

### Chief Complaint Fever Malaise

### Review of Systems Hematuria duration 4 days Nausea vomit 6 days

### Physical Examination Swollen lymph nodes in the armpits

### Diagnosis Streptococcal infection

### Differential Diagnosis Renal failure Glomerulonephritis

### Laboratory CBC SMA12 Renal CTScan

### Assessment and Plan Streptococcal Infection Kidney failure

### Treatment See below

### Medications Oral prednisone 10 days

### Surgery None

### Recommendation Reduce protein intake Rest

### Follow-Up Return in one week

Upon completion of said process, any physician working on the data and information on a plurality of his/her patients, the data and information on individual and different patients in individual templates are submitted by the physician for placement or placements into the computer/server database or databases to achieve the goals and objectives of the present invention.

Said method and processes are implemented by the computer program or programs invented and developed by the present patent applicant. The present invention uses also the commercially available computer software (plural), programs and computer languages such as, but not limited to, those made and sold by Microsoft Corporation such as, but not limited to, SQL such as, but not limited to Microsoft SQL, MySQL and the like, Internet Explorer, browsers, Visual Studio and .Net and the like and their databases and derivatives, other computer corporations' and companies' programs, languages, codes and databases and their derivatives which are commonly and routinely used by computer engineers and programmers such as, but not limited to, PHP, PERL, C languages, such as, but not limited to, C, C+, C++, C#, JAVA and their derivatives.

Consequent to the incorporations of said data and information using computer programs, software mentioned herein and the like, the products of said incorporations are stored in and retrieved from database or databases to be displayed on the viewing screens and comprehensible and use by patients and physicians.

Although it has been described in pending earlier patent applications, said data and information are words, terms, phrases, synonyms, codes, numbers, sentences, etc. used and use by physicians in all—approximately 80—medical and surgical specialties and practices to describe and document data and information on diseases, illnesses, disorders, health and health-care of patients.

It is understood that—by laws and ethics—each electronic package or file of second and resultant health and health-care data and information on a patient belongs or relates to said patient and is generated by a physician so that said patient and physician and authorized physicians are able to view on the viewing screens of electronic devices and use said data and information. Similarly, each electronic file of first health and health-care data and information on a patient and individual products or results of said incorporations of said second health and health-care data and information with said first health and health-care data and information belong or relate to said patient and are viewable on viewing screens and used by said patient, physician and authorized physicians.

Although various preferred embodiments of the present invention have been described, it will be appreciated by those skilled in the art that adaptations and variations may be made without departing from the spirit and the scope of the claims of the present invention.

1. A system of using words and terms also known as word and term headers in the electronic files comprising health and health-care data and information on patient generated by physicians and in the templates of word and term headers for effecting the displays of health and health-care data and information on patients on the viewing screens of the electronic devices for the inspections, manipulations, editions including additions, corrections and deletions by physicians, for effecting the placements or insertions of data and information into the database or databases, for effecting the insertions or placements of second health and health-care data and information into first health and health-care data and information generated by patients and physicians, for effecting the incorporations of second health and health-care data and information into first health and health-care data and information generated by patients and physicians, for effecting the associations of second health and health-care data and information with first health and health-care data and information, for effecting the associations and relations of second health and health-care data and information with first health and health-care data and information, for effecting the expansions of data and information by patients and physicians and for effecting the storage of health and health-care data and information in the database or databases, and for effecting the retrievals, viewing on the viewing screens, manipulations, editions and uses of the products of said method and processes by physicians and patients comprises:
a process of identifying word and term headers;
a process of displaying word and term headers;
a process of using word and term headers;
a process of identifying word and term headers in the health and health-care data and information;
a process of finding or searching word and term headers in health and health-care data and information;
a process of finding the presences of word and term headers in health and health-care data and information;
a process of finding and determining the presences of word and term headers in health and health-care data and information;
a process of identifying the relative positions of word and term in health and health-care data and information;
a process of finding and determining the locations and positions of word and term headers health and health-care data and information;
a process of identifying the relative positions of words, terms and phrases relative to word and term headers in health and health-care data and information;
a process of determining the locations of the related secondary words, terms and phrases relating to word and term headers in health and health-care data and information;
a process of accounting for the locations of the related secondary words, terms and phrases relating to word and term headers in health and health-care data and information;
a process of using word and term headers in health and health-care data and information on patients for organizing data and information for displaying to and viewing and manipulating by physicians;
a process of using word and term headers in health and health-care data and information on patients for organizing data and information for placing data and information in the electronic database or databases;
a process of using word and term headers for organizing data and information for placing data and information in the electronic database or databases;
a process of using word and term headers for placing data and information in the electronic database or databases;
a process of using word and term headers in health and health-care data and information for organizing data and information in the electronic database or databases;
a process of using word and term headers for effecting the insertions or placements of health and health-care data and information into first health and health-care data and information;
a process of using word and term headers for effecting the incorporations of second health and health-care data and information with first health and health-care data and information in the database or databases;
a process of using word and term headers for effecting the associations of second health and health-care data and information with first health and health-care data and information in the database or databases;
a process of using word and term headers for relating health and health-care data and information in the database or databases;
a process of using word and term headers for effecting the storage in the database or databases of the products of said method and processes;
a process of using word and term headers for effecting the retrievals, displays of data and information on the viewing screens for manipulations, editions and uses by physicians and patients; and
a process of repeatedly using word and term headers for effecting the repetitions of said processes.

2. A system of using word and term headers in the outcomes of speech recognition of second health and health-care data and information on patients generated by physicians and in a template means for entering or typing health and health-care data and information on patients generated by typing using electronic keyboards by physicians for effecting the displays of data and information on the viewing screens of the electronic devices for the inspections, manipulations, editions including additions, corrections and deletions by physicians, for effecting the placements or insertions of data and information into the database or databases, for effecting the insertions or placements of second health and health-care data and information into first health and health-care data and information generated by patients and physicians, for effecting the incorporations of second health and health-care data and information into first health and health-care data and information generated by patients and physicians, for effecting the associations of second health and health-care data and information with first health and health-care data and information generated by patients and physicians and for effecting the storage of health and health-care data and information in the database or databases, and for effecting the retrievals, viewing on the viewing screens, manipulations, editions and uses of the products of said method and processes by physicians and patients, wherein in individual outcomes of speech recognition word and term headers are identified, searched or found and the locations and relationships of word and term headers are identified, determined and accounted and the related secondary words, terms and phrases relating to word and term headers are identified, determined, accounted and related to the positions and locations of word and term headers and wherein health and health-care data and information on patients are entered or typed into said templates means for entering or typing health and health-care data and information according to the word and term headers comprises:
a process of identifying word and term headers;
a process of displaying word and term headers;
a process of using word and term headers;
a process of identifying word and term headers in the health and health-care data and information;
a process of finding or searching word and term headers in health and health-care data and information;
a process of finding the presences of word and term headers in health and health-care data and information;
a process of finding and determining the presences of word and term headers in health and health-care data and information;
a process of identifying the relative positions of word and term in health and health-care data and information;
a process of finding and determining the locations and positions of word and term headers health and health-care data and information;
a process of identifying the relative positions of words, terms and phrases relative to word and term headers in health and health-care data and information;
a process of determining the locations of the related secondary words, terms and phrases relating to word and term headers in health and health-care data and information;
a process of accounting for the locations of the related secondary words, terms and phrases relating to word and term headers in health and health-care data and information;
a process of using word and term headers in health and health-care data and information on patients for organizing data and information for displaying to and viewing and manipulating by physicians;
a process of using word and term headers in health and health-care data and information on patients for organizing data and information for placing data and information in the electronic database or databases;
a process of using word and term headers for organizing data and information for placing data and information in the electronic database or databases;
a process of using word and term headers for placing data and information in the electronic database or databases;
a process of using word and term headers in health and health-care data and information for organizing data and information in the electronic database or databases;
a process of using word and term headers for effecting the insertions or placements of health and health-care data and information into first health and health-care data and information;
a process of using word and term headers for effecting the incorporations of second health and health-care data and information with first health and health-care data and information in the database or databases;
a process of using word and term headers for effecting the associations of second health and health-care data and information with first health and health-care data and information in the database or databases;
a process of using word and term headers for relating health and health-care data and information in the database or databases;
a process of using word and term headers for effecting the storage in the database or databases of the products of said method and processes;
a process of using word and term headers for effecting the retrievals, displays of data and information on the viewing screens for manipulations, editions and uses by physicians and patients; and
a process of repeatedly using word and term headers for effecting the repetitions of said processes.

3. A method of using words and terms in the outcomes of speech recognition of health and health-care data and information on patients generated by physicians wherein said words and terms also known as word and term headers are identified, searched or found and the locations and relationships of word and term headers are identified, determined and accounted and the related secondary words, terms and phrases relating to word and term headers are identified, determined, accounted and related to the positions and locations of word and term headers in individual outcomes for effecting the displays of data and information on the viewing screens of the electronic devices, for effecting the inspections, manipulations, editions including additions, corrections and deletions by physicians, for effecting the placements or insertions of data and information into the database or databases, for effecting the insertions or placements of health and health-care data and information also known as second health and health-care data and information into first health and health-care data and information generated by patients and physicians, for effecting the incorporations of second health and health-care data and information into first health and health-care data and information, for effecting the associations and relations of second health and health-care data and information with first health and health-care data and information and for effecting the storage of data and information in the database or databases, and for effecting the retrievals, viewing on the viewing screens, manipulations, editions and uses of the products of said method and processes by physicians and patients comprises:
a process of identifying word and term headers;
a process of using word and term headers;
a process of identifying word and term headers in the health and health-care data and information on patients;
a process of identifying word and term headers in individual outcomes of speech recognition of health and health-care data and information on patients;
a process of finding or searching word and term headers in individual outcomes of speech recognition of health and health-care data and information on patients;
a process of finding the presences of word and term headers in individual outcomes of speech recognition of health and health-care data and information on patients;
a process of finding and determining the presences of word and term headers in individual outcomes of speech recognition of health and health-care data and information on patients;
a process of identifying the relative positions of word and term headers in individual outcomes of speech recognition of health and health-care data and information on patients;
a process of finding and determining the locations and positions of word and term headers in individual outcomes of speech recognition of health and health-care data and information on patients;
a process of identifying the relative positions of words, terms and phrases relative to word and term headers in individual outcomes of speech recognition of health and health-care data and information on patients;
a process of determining the locations of the related words, terms and phrases relating to word and term headers in individual outcomes of speech recognition of health and health-care data and information on patients;
a process of accounting for the locations of the related secondary words, terms and phrases relating to word and term headers in individual outcomes of speech recognition of health and health-care data and information on patients;
a process of using word and term headers in the outcomes of speech recognition of health and health-care data and information on patients for organizing data and information for displaying to and viewing and manipulating by physicians;
a process of using word and term headers in the outcomes of speech recognition of health and health-care data and information on patients for organizing data and information for placing data and information in the electronic database or databases;
a process of using word and term headers in the outcomes of speech recognition of health and health-care data and information on patients for organizing data and information in the electronic database or databases;
a process of using word and term headers for effecting the insertions or placements of second health and health-care data and information into first health and health-care data and information;
a process of using word and term headers for effecting the incorporations of second health and health-care data and information with first health and health-care data and information in the database or databases;
a process of using word and term headers for effecting the associations of second health and health-care data and information with first health and health-care data and information in the data or databases;
a process of using word and term headers for relating health and health-care data and information in the database or databases;
a process of using word and term headers for effecting the storage of the products of said method and processes in the database or databases;
a process of using word and term headers for effecting the retrievals, displays of data and information on the viewing screens;
a process of using word and term headers for effecting the retrievals, displays of data and information for manipulations, editions and uses by physicians and patients; and
a process of repeatedly using word and term headers for effecting the repetitions of said processes.
